(19) United States
(12) Patent Application Publication
(10) Pub. No.: US 2026/0001617 A1
(43) Pub. Date: Jan. 1, 2026

(54) DRIVE DEVICE FOR A VEHICLE OPERATED BY MUSCLE POWER, AND A MICRO-MOBILITY VEHICLE COMPRISING THE DRIVE DEVICE

(71) Applicant: ZF Friedrichshafen AG, Friedrichshafen (DE)

(72) Inventors: Fabian Kutter, Kressbronn (DE); Philipp Rechenbach, Markdorf (DE); Uwe Griesmeier, Markdorf (DE); Johannes Kaltenbach, Friedrichshafen (DE)

(21) Appl. No.: 18/869,121

(22) PCT Filed: May 15, 2023
(86) PCT No.: PCT/EP2023/062951

§ 371 Date: Nov. 25, 2024

(30) Foreign Application Priority Data
May 25, 2022 (DE) 10 2022 205 263.3

(51) Int. Cl. B62M 6/55; B62M 11/18

(52) U.S. Cl. CPC B62M 6/55; B62M 11/18

(57) ABSTRACT

A propulsion unit includes a crank device (3) for receiving muscle power and a speed modulation gear (1) for transmitting the muscle power onto an output gear (10) for propelling a vehicle. An electric machine (2) and a housing (6) can be mounted on the vehicle for accommodating at least some elements of the propulsion unit. The speed modulation gear (1) is in the form of a stepped planetary gear set with at least one stepped planetary gear (15), corresponding ring gears (12, 14), and an input element. The crank device (3) is couplable to one of the ring gears (12, 14), and an output element (22) of the electric machine (2) is coupled to the input element. The speed modulation gear (1) is mounted rotatably with respect to the housing (6) such that rotation of the electric machine (2) and rotation of the crank device (3) can be superimposed and transmitted onto the output gear (10).

### CROSS-REFERENCE TO RELATED APPLICATIONS

The present application is related and has right of priority to German Patent Application No. DE102022205263.3.0 filed on May 25, 2022 and is U.S. national phase of PCT/EP2023/062951 filed on May 15, 2023, both of which are incorporated by reference in their entireties for all purposes.

### TECHNICAL FIELD

The present invention relates generally to a propulsion unit for a vehicle operated by muscle power, in which a propulsive force for propelling the vehicle is generated at least intermittently by the muscle power of a rider of the vehicle. The present invention further relates generally to a vehicle equipped with such a propulsion unit.

### BACKGROUND

DE 10 2009 045 447 relates to a propulsion unit for a two-wheeled vehicle, in which a propulsive force introduced by muscle power can be assisted by an electrical propulsion unit. In this propulsion unit, a planetary transmission is provided for reducing the output rotational speed of the electrical propulsion unit.

CN 1237520 A relates to a propulsion unit for a vehicle operated by muscle power, which vehicle can be in the form of a two-wheeled vehicle. In this propulsion unit, a gear unit is used, with which the propulsive force of an electric machine and a propulsive force introduced via muscle power of the rider can be superimposed.

### SUMMARY

Example aspects of the invention relate to a propulsion unit for a vehicle operated by muscle power, which propulsion unit has a crank device for receiving muscle power and a speed modulation gear for transmitting the muscle power onto an output gear. Via the output gear, a propulsive force for propelling the vehicle is output. Furthermore, the propulsion unit has an electric machine and a housing which can be mounted on the vehicle for accommodating at least some elements of the propulsion unit. The speed modulation gear is in the form of a stepped planetary gear set having at least one stepped planetary gear, corresponding ring gears, and an input element. The crank device is coupleable to one of the ring gears and an output element of the electric machine is coupled to the input element. The speed modulation gear is mounted rotatably with respect to the housing so that a rotation of the electric machine and a rotation of the crank device are superimposed and transmitted onto the output gear.

The electric machine is designed, in this context, as an electric machine for rotational speed control, which rotational speed control relates to the output gear and is brought about in conjunction with the speed modulation gear. The crank device can have a crank axle, which carries corresponding crank arms on both sides. Via the crank arms having pedals mounted thereon, the propulsive force generated by muscle power can be applied onto the crank axle. The input element can be, in this context, an element of the speed modulation gear that is suitable for introducing a propulsive force of the electric machine into the speed modulation gear.

According to one example embodiment, the stepped planetary gear can have a planet gear with a large diameter and, coupled thereto, a planet gear with a small diameter. The speed modulation gear can have a ring gear with a large diameter, which ring gear engages with the planet gear having a large diameter, and a ring gear having a small diameter, which ring gear engages with the planet gear having a small diameter.

The stepped planetary gear can have two planet gears, which are coupled together and have different effective diameters. A planet gear having a large diameter can be provided, the diameter of which is larger than that of the further planet gear, the effective diameter of which is correspondingly smaller than that of the planet gear having a large diameter. Therefore, two ring gears having different effective diameters can be provided. A ring gear having a large diameter is provided, the effective diameter of which is larger than that of the further ring gear, which therefore has a smaller diameter than the ring gear with the large diameter. The ring gears can each have an internal toothing. The internal toothing of the ring gears can engage with corresponding external toothings of the planet gears for transmission of force. The stepped planetary gear can be rotatably mounted, so that the planet gear having a large diameter and the planet gear having a small diameter rotate at the same rotational speed. The ring gears can be rotated during operation of the speed modulation gear at rotational speeds that differ from one another.

According to one example embodiment, the speed modulation gear can have a sun gear with a small diameter, which sun gear engages with the planet gear having a large diameter. It can be provided that the planet gear having a small diameter engages only with the ring gear having a small diameter. The sun gear with a small diameter can form the input element with which the output element of the electric machine is coupled. In this example embodiment, it can be provided that the planet gear having a small diameter cannot engage with any element other than with the ring gear having a small diameter.

According to one example embodiment, the speed modulation gear can have a sun gear with a large diameter, which sun gear engages with the planet gear having a small diameter. It can be provided that the planet gear having a large diameter engages only with the ring gear having a large diameter. The sun gear with a large diameter can form the input element with which the output element of the electric machine is coupled. According to this example embodiment, it can be provided that the planet gear having a large diameter does not engage with any element other than with the ring gear having a large diameter.

According to one example embodiment, the speed modulation gear can have a stepped planet spider, which holds the at least one stepped planetary gear in a manner that is rotatable and is movable on a circular path about an axis of symmetry of the speed modulation gear. The stepped planet spider can form the input element with which the output element of the electric machine is coupled. It can be provided that the stepped planetary gear engages only with the corresponding ring gears. According to this example embodiment, it can be provided that the stepped planetary gear does not engage with any elements other than with the corresponding ring gears. The corresponding ring gears are the ring gear with a large diameter and the ring gear with a small diameter. The stepped planet spider can have any shape, as long as the stepped planet spider is suitable for rotatably holding the stepped planetary gear and, at the same time, holding the stepped planetary gear such that the stepped planetary gear is movable on a circular path about the axis of symmetry of the speed modulation gear. The stepped planet spider according to this example embodiment can then form the input element with which the output element of the electric machine is coupled. Via this coupling of the output element of the electric machine and the input element in the form of a stepped planet spider, the stepped planetary gear can be moved on the circular path thereof.

According to one example embodiment, the electric machine and the speed modulation gear can be coaxial. In particular, it can be provided that the electric machine and the speed modulation gear are arranged coaxially on an axis of symmetry, wherein the electric machine and the speed modulation gear are adjacent to one another in the axial direction.

According to one example embodiment, a freewheel unit can be provided in the force transmission path between the crank device and the speed modulation gear, which freewheel unit permits a transmission of force between the crank device and the speed modulation gear in only one direction of rotation. It can be provided that, in a first direction of rotation of the crank device, a propulsive force is transmitted onto the speed modulation gear, and, in a second direction of rotation, which is opposite the first direction of rotation, force cannot be transmitted from the crank device onto the speed modulation gear. The freewheel unit can have any shape, as long as the aforementioned function is fulfilled.

According to one example embodiment, an electrical propulsion unit can also be provided, which electrical propulsion unit can be coupled via an output element to an input element of the speed modulation gear, so that the propulsive force of the electrical propulsion unit can be transmitted onto the output gear of the speed modulation gear. The electrical propulsion unit is provided in addition to the electric machine, which is provided in conjunction with the speed modulation gear for rotational speed control. In one example embodiment, the electrical propulsion unit can be designed with a higher output power than the electric machine for rotational speed control.

According to one example embodiment, a reduction gear for reducing the rotational speed output by the electrical propulsion unit can be provided between the output element of the electrical propulsion unit and the input element of the speed modulation gear. Any type of reduction gear can be used, as long as the propulsive force output by the electrical propulsion unit can be applied onto the speed modulation gear at a reduced rotational speed. Due to the reduction of the rotational speed, the available torque can be increased from the torque of the electrical propulsion unit.

According to one example embodiment, the reduction gear can have one of a planetary gear set and a spur gear set. It can be provided that the reduction gear has a planetary gear set, which is coaxial to the output element of the electrical propulsion unit. It can also be provided that a spur gear set having at least two spur gears is provided. With the spur gear set, which has at least two spur gears, it can be achieved that an offset is created between the output element of the electrical propulsion unit and the input element of the speed modulation gear. The spur gear set can have more than two spur gears, in particular three spur gears. Furthermore, it can be provided that more than one planetary gear set is provided, wherein the planetary gear sets can be interconnected in series.

According to one example embodiment, the electrical propulsion unit can be axially offset relative to the speed modulation gear and the electric machine. In particular, it can be provided that the electrical propulsion unit is axially offset relative to the axis of symmetry of the speed modulation gear and the electric machine for rotational speed control. A spur gear set can be provided, which spur gear set is designed to compensate the axial offset between the electrical propulsion unit and the speed modulation gear as well as the electric machine. With this configuration, a compact propulsion unit can be made available.

According to one example embodiment, the propulsive force of the electrical propulsion unit can be applied directly onto an element of the speed modulation gear that supports the output gear. In particular, the propulsive force of the electrical propulsion unit can be applied onto the element of the speed modulation gear that supports the output gear without passing through the speed modulation gear. The propulsive force of the electric machine can be the propulsive force that is generated after passing through a reduction gear, if applicable. The element of the speed modulation gear that supports the output gear can be any element that is force-lockingly connected to the output gear. With this example embodiment, it is achieved that the application of a propulsive force onto the element supporting the output gear directly brings about an application of the propulsive force onto the output gear. The element supporting the output gear can have a toothing with which an element of the electrical propulsion unit and, if applicable, of the reduction gear engages for transmission of force.

According to one example embodiment, the crank device can be couplable to the ring gear having a small diameter. When the crank device is couplable to the ring gear having a small diameter, the propulsive force applied onto the crank device can be applied onto the ring gear having a small diameter. It can be provided that the crank device is decoupled from the ring gear in predetermined operating states.

According to one example embodiment, the crank device can be couplable to the ring gear having a large diameter. When the crank device is couplable to the ring gear having a large diameter, the propulsive force applied onto the crank device can be applied onto the ring gear having a large diameter. It can be provided that the crank device is decoupled from the ring gear in predetermined operating states.

According to one example embodiment, the propulsive force of the electrical propulsion unit can be transmitted onto the output gear of the speed modulation gear after passing through the speed modulation gear. In particular, the propulsive force of the electrical propulsion unit can be applied onto the element of the speed modulation gear that supports the output gear by incorporating the speed modulation gear.

According to one example embodiment, it can be provided that the output element of the electric machine is fixable with respect to the housing via a freewheel unit. With this example embodiment, it is achieved that the electric machine, which is provided in connection with the speed modulation gear for rotational speed control, can be fixed, so that the electric machine is non-rotatably held. As a result, the rotational speed control by the electric machine in conjunction with the speed modulation gear can be prevented. The freewheel unit can be in the form of an engageable and disengageable freewheel unit. The function as an engageable and disengageable freewheel unit can be brought about by an electromagnetic element, a hydraulic element, or a mechanical element. The function for engaging or disengaging the freewheel unit can be implemented via an instruction from the rider, an instruction that is output by a control device, or in any other way. The freewheel unit can be in the form of a rotational speed-dependent freewheel unit. The blocking function can be limited to one direction of rotation. The freewheel unit can therefore be in the form of an engageable and disengageable freewheel unit.

According to one example embodiment, a control device can be provided, which control device controls the operating state, in particular the rotational speed and the direction of rotation, of the electric machine on the basis of supplied information, so that a predetermined ratio between the rotational speed of the crank device and the output gear sets in. The ratio can be increased or decreased by controlling the rotational speed of the electric machine in response to the rotational speed of the crank device. Furthermore, it can be achieved that, at a variable rotational speed of the crank device, the rotational speed of the output gear remains constant or can be held within a predetermined rotational speed range by controlling the rotational speed of the electric machine. Furthermore, it can be provided that the control device controls the direction of rotation of the electric machine, so that predetermined ratios between the rotational speed of the crank device and the rotational speed of the output gear can be brought about.

According to one example embodiment, the electrical propulsion unit can be designed for a recuperative operation, wherein at least some of the electrical energy generated in the recuperative operation can be used for operating the electric machine. The recuperative operation of the electrical propulsion unit can be brought about by setting the electrical propulsion unit into rotation by driving the crank device. The recuperative operation of the electrical propulsion unit can be alternatively or additionally brought about by setting the electrical propulsion unit into rotation by the propulsive operation of the vehicle. The electrical energy generated as a result can be used directly or indirectly via an electrical energy store device for operating the electric machine. With this example embodiment, it is achieved that rotational speed control can be brought about by the electric machine without the need to supply electrical energy from outside.

According to one example embodiment, an electrical energy store device can also be provided, which electrical energy store device makes electrical energy available for operating the propulsion unit. The electrical energy store device can be an accumulator for storing electrical energy. The electrical energy store device can be chargeable via an external energy source. The electrical energy store device can be removable from the associated vehicle, which can be in the form of a micromobility vehicle. A micromobility vehicle is a vehicle that is suitable for individual transport and can be in the form of, for example, an e-bike, a (speed) pedelec, a cargo bike, a velomobile, or the like. A micromobility vehicle can be in the form of a two-wheeled, three-wheeled, or four-wheeled vehicle.

The electrical energy store device can also be designed such that the electrical energy store device, in interaction with the control device, can store electrical energy that is generated in the recuperative operation of the electrical propulsion unit.

The above-described propulsion unit can be provided on a vehicle which is operated at least intermittently by muscle power. The vehicle can be any micromobility vehicle that is suitable for operation by muscle power, such as a two-wheeled vehicle, a three-wheeled vehicle, a cargo bicycle, a manually operated vehicle, and other suitable example embodiments of vehicles.

According to another perspective, a micromobility vehicle having at least two wheels is provided, which micromobility vehicle has a propulsion unit having one or more of the above-described features. The output gear of the propulsion unit is coupled to one of the wheels for propelling the micromobility vehicle. The output gear can be coupled via a force transmission element to one of the wheels for propelling the micromobility vehicle. The micromobility vehicle can also have an electrical energy store device, which is designed to output and receive electrical energy for operating the propulsion unit. Furthermore, the micromobility vehicle can have a control device, which is designed to operate the propulsion unit.

### BRIEF DESCRIPTION OF THE DRAWINGS

FIG. 1 is a schematic view of a propulsion unit for a vehicle operated by muscle power according to a first example embodiment;

FIG. 2 is a schematic view of a propulsion unit for a vehicle operated by muscle power according to a second example embodiment;

FIG. 3 is a schematic view of a propulsion unit for a vehicle operated by muscle power according to a third example embodiment;

FIG. 4 is a schematic view of a propulsion unit for a vehicle operated by muscle power, which is a modification of the example embodiment shown in FIG. 2;

FIG. 5 is a schematic view of a propulsion unit for a vehicle operated by muscle power, which is a modification of the example embodiment shown in FIG. 1;

FIG. 6 is a schematic view of a propulsion unit for a vehicle operated by muscle power according to a fourth example embodiment; and

FIG. 7 is a schematic view of a propulsion unit for a vehicle operated by muscle power according to a fifth example embodiment.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

In the following, example embodiments of the propulsion unit according to the invention for a vehicle operated by muscle power are described with reference to the drawings.

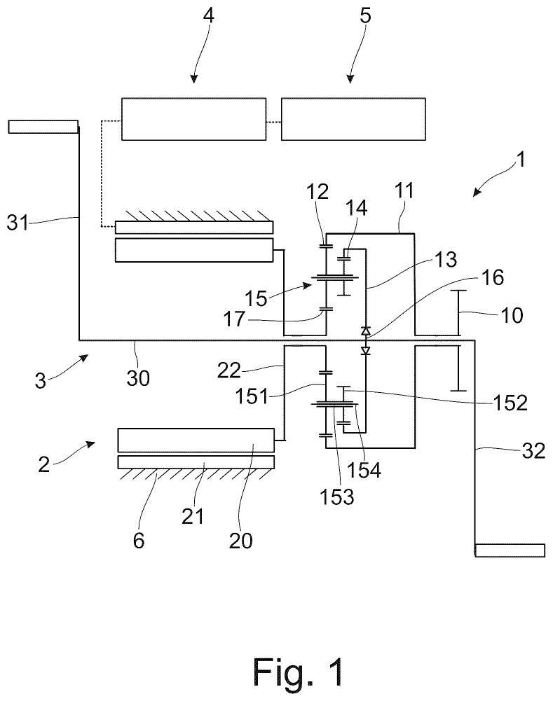

FIG. 1 shows, in a schematic view, a propulsion unit for a vehicle operated by muscle power according to a first example embodiment. As is apparent in FIG. 1, the propulsion unit has a speed modulation gear 1, an electric machine 2, which is used for rotational speed control, and a crank device 3. In addition, a control device 4 and an electrical energy store device 5 are provided. The aforementioned assemblies of the propulsion unit and the mode of operation thereof are explained in the following with reference to an application on a micromobility vehicle in the form of a two-wheeled vehicle.

The speed modulation gear 1 has an output gear 10 on the right side, as is apparent in FIG. 1. The output gear 10 is in the form of a sprocket in the present example embodiment, which sprocket is connected to a rear wheel of a two-wheeled vehicle via a drive chain for transmission of force. The output gear 10 is connected to a ring gear carrier 11 via a hollow shaft element. The rotation of the ring gear carrier 11 is transmitted directly onto the output gear 10. The ring gear carrier 11 has a ring gear 12 provided thereon. A crank device 3 extends coaxially through the output gear 10, which crank device has a crank axle 30 on which respective crank arms 31, 32 are provided on the left side and the right side thereof. The orientation of the crank arms 31, 32 relative to the crank axle 30 is offset by one hundred and eighty degrees (180°). Pedals are provided at the end of the crank arms 31, 32. Via the pedals and the crank arms 31, 32, a propulsive force can be applied onto the crank axle 30 by the rider of the two-wheeled vehicle.

In the present example embodiment, a freewheel unit 16 is provided on the crank axle 30. The freewheel unit 16 is coupled on one side thereof to the crank axle 30 and on the other side thereof to a ring gear carrier 13. The freewheel unit 16 causes a rotation of the crank axle 30 relative to the ring gear carrier 13 in one direction to be transmitted onto the ring gear carrier 13, while force is not transmitted onto the ring gear carrier 13 when the crank axle 30 is rotated relative to the ring gear carrier 13 in the opposite direction. The ring gear carrier 13 carries a ring gear 14. The ring gear 12 provided on a further ring gear carrier 11 is a ring gear having a large diameter, while the ring gear 14 provided on the ring gear carrier 13 is a ring gear having a small diameter. In particular, the ring gear 12 has a larger effective diameter than the ring gear 14.

A plurality of stepped planetary gears 15 is provided in the speed modulation gear 1. In the present example embodiment, three identically designed stepped planetary gears 15 are provided around the circumference of the axis of symmetry of the speed modulation gear 1, which axis of symmetry is formed by the crank axle 30. In the following, only one stepped planetary gear 15 is explained and the configuration of the further stepped planetary gears is correspondingly identical. The stepped planetary gear 15 has a planet gear 151 with a large diameter and a planet gear 152 with a small diameter. The planet gears 151, 152 are rigidly coupled via a stepped planetary gear pin 153. The stepped planetary gear pin 153 is rotatably held by a stepped planet carrier 154.

The stepped planetary gears 15 provided in the speed modulation gear 1 are each held by the stepped planet carrier 154 in a manner that is rotatable and is movable on a common circular path about the axis of symmetry of the speed modulation gear 1. In this case, the toothing of the ring gear 12 having a large diameter is engaged with the toothing of the planet gear 151 having a large diameter, while the toothing of the ring gear 14 having a small diameter is engaged with the toothing of the planet gear 152 having a small diameter.

In the present example embodiment, the speed modulation gear 1 has a sun gear 17. The sun gear 17 engages via the toothing thereof into the toothing of the planet gear 151 having a large diameter. The sun gear 17 is in the form of a sun gear having a small diameter and, in the present example embodiment, is connected to an output element 22, which is described at another point.

In this way, the speed modulation gear 1 is designed as a stepped planetary gear set in which a propulsive force can be introduced from the crank device 3 as well as from the output element 22, which is coupled to the sun gear 17 having a small diameter. The propulsive force can be output in the speed modulation gear 1 according to the present example embodiment via the output gear 10. In the present example embodiment, the sun gear 17 having a small diameter acts as an input element.

In FIG. 1, an electric machine 2 is shown on the left side of the speed modulation gear 1. The electric machine 2 has a symmetrical configuration and is symmetrical to the crank axle 30. The crank axle 30 extends through the center of the electric machine 2. The electric machine 2 has a rotor 20, which is rotatably mounted. The electric machine 2 also has a stator 21, which is non-rotatably mounted on a housing 6. The rotor 20 is connected to the output element 22. Therefore, a rotation of the electric machine 2 can be transmitted onto the sun gear 17 having a small diameter via the output element 22.

As is apparent in FIG. 1, the control device 4 is connected to the electric machine 2. The electric machine 2 is operated in the present example embodiment by electrical energy which is stored in the electrical energy store device 5. The control device 4 controls the rotational speed and the direction of rotation of the electric machine 2, so that the corresponding rotation can be introduced via the sun gear 17 having a small diameter as an input element of the speed modulation gear. In the present example embodiment, the control device 4 is supplied with signals, or information, which are/is input by a rider of the two-wheeled vehicle.

The function of the propulsion unit according to the first exemplary embodiment, which is shown in FIG. 1, is described in the following.

In an operating state in which the electric machine 2 is not supplied with electrical energy, the rider of the two-wheeled vehicle can drive the crank device 3 via the pedal cranks for forward travel of the two-wheeled vehicle. The propulsive force is transmitted from the crank device 3 via the crank axle 30, the freewheel unit 16, and the ring gear carrier 13 onto the ring gear 14 having a small diameter. As a result, the stepped planetary gear 15 is set into rotation via the planet gear 152 having a small diameter and moved on a circular path. Due to the rotation of the stepped planetary gear 15 and the revolution of the stepped planetary gear 15, the ring gear carrier 11 and thus the output gear 10 are rotated via the engagement of the planet gear 151 having a large diameter with the ring gear 12 having a large diameter. Due to the ratios of the toothings of the individual planet gears and ring gears, a predetermined transmission ratio between the rotational speed of the crank axle 30 and the output gear 10 is brought about. Due to the coupling of the provided stepped planetary gears 15 with the planet carrier, the above-described sequence of motions applies for each of the stepped planet carriers 15.

In a further operating state, the electric machine 2 is supplied with electrical energy, so that the electric machine rotates. The electric machine 2 can be driven in a direction of rotation that corresponds to the direction of rotation in which the crank axle 30 is rotated. As a result, the rotation of the output element 22 of the electric machine 2 is transmitted onto the stepped planetary gear 15 via the sun gear 17 having a small diameter. In this case, the rotational speed of the electric machine 2 and the rotational speed of the crank axle 30 are superimposed on each other. As a result, the rotational speed ratio and thus the transmission ratio between the crank axle 30 and the output gear 10 can be adjusted depending on the rotational speed of the electric machine 2.

In a further operating state, the electric machine 2 can be rotated in the direction that is opposite the direction in which the crank axle 30 rotates. In this case as well, the rotational speed of the electric machine 2 and the rotational speed of the crank axle 30 are superimposed, so that a variable transmission ratio between the rotational speed of the crank axle 30 and the output gear 10 results.

Via the control device 4, in the present example embodiment, the rider can specify a transmission ratio between the crank axle 30 and the output gear 10 using an input element (not shown). The control device 4 then controls, on the basis of the specification from the rider of the two-wheeled vehicle, the direction of rotation and the rotational speed of the electric machine 2, so that the desired transmission ratio between the crank axle 30 and the output gear 10 sets in. During the operation of the propulsion unit, the speed modulation gear 1 rotates about the axis thereof. In particular, the speed modulation gear is not supported in a rotationally fixed manner with respect to the housing 6. Furthermore, in this example embodiment, the planet gear 152 having a small diameter engages via the toothing thereof only with the ring gear 14 having a small diameter.

In a modified example embodiment, corresponding rotational speed sensors and speed sensors are provided, the signals of which are introduced into the control device 4. The control device 4 can determine, on the basis of the signals, an optimal transmission ratio between the crank axle 30 and the electric machine 2 and control the electric machine 2 accordingly. In this case, an infinitely variable, automatic transmission ratio control for the propulsion unit is achieved.

If the rider of the two-wheeled vehicle stops driving the crank axle 30 via the pedal cranks, the speed modulation gear 1 can continue to rotate due to the arrangement of the freewheel unit 16. Furthermore, it is possible that the rider rotates the crank axle 30 in reverse via the pedal cranks, wherein, in this case, due to the arrangement of the freewheel unit 16, a propulsive force is not introduced into the speed modulation gear 1.

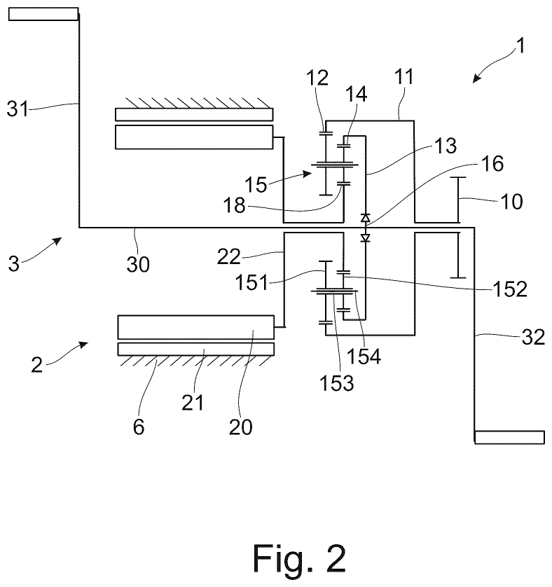

A propulsion unit according to a second example embodiment is described in the following on the basis of the schematic view shown in FIG. 2. For the sake of simplicity, only the differences between the propulsion unit shown in FIG. 2 and the propulsion unit shown in FIG. 1 are explained. As is apparent in FIG. 2, an output element 22 is provided at the electric machine 2. The output element 22 is formed in deviation from the configuration shown in FIG. 1 with a sun gear 18 having a large diameter, which sun gear engages with the planet gear 152 having a small diameter. The planet gear 151 having a large diameter is engaged in this example embodiment only with the ring gear 12 having a large diameter.

The mode of operation and the advantages of the second example embodiment shown in FIG. 2 are the same as those of the example embodiment shown in FIG. 1. By the configuration shown in FIG. 2, an alternative transmission ratio of the speed modulation gear can be provided.

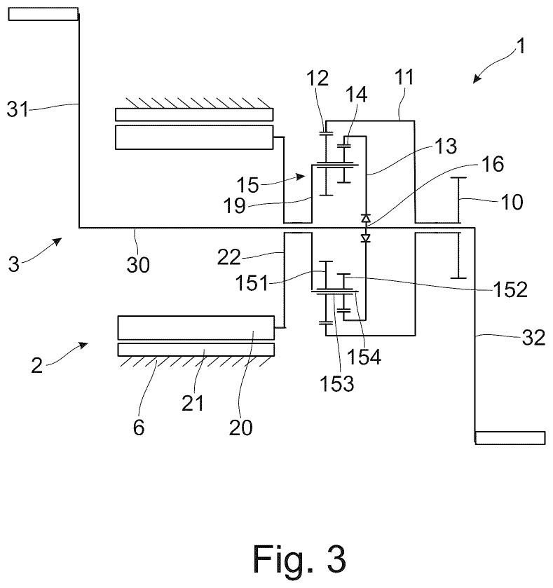

A propulsion unit according to a third exemplary embodiment is described in the following on the basis of the schematic view shown in FIG. 3. In the following, only the differences between the propulsion unit shown in FIG. 3 and the propulsion unit shown in FIG. 1 are explained.

As in the propulsion unit shown in FIG. 1, the electric machine 2 has the output element 22. The output element 22 of the electric machine 2 in the exemplary embodiment shown in FIG. 3 is connected to a stepped planet spider 19, in deviation from the configuration shown in FIG. 1. The stepped planet spider 19 is connected to the stepped planet carrier 154, which holds the stepped planetary gears 15 such that they are rotatable and are movable on a circular path. Therefore, a rotation of the electric machine 2 is transmitted onto the stepped planet spider 19 via the output element 22, so that the stepped planetary gears 15 are moved on a circular path about the axis of symmetry of the speed modulation gear. As is apparent in FIG. 3, the planet gear 151 having a large diameter engages only with the ring gear 12 having a large diameter, while the planet gear 152 having a small diameter engages only with the ring gear 14 having a small diameter. A sun gear is not provided in the propulsion unit of the exemplary embodiment shown in FIG. 3. The function and the advantages of the propulsion unit shown in FIG. 3 are the same as those described with reference to FIG. 1. By the configuration shown in FIG. 3, alternative transmission ratios between the electric machine 2, the speed modulation gear, the output gear 10, and the crank axle 30 can be obtained.

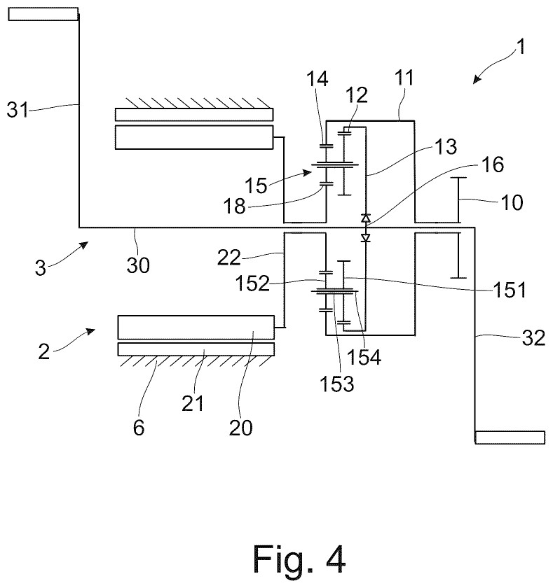

FIG. 4 shows a modification of the example embodiment shown in FIG. 2. In deviation from the configuration of the propulsion unit shown in FIG. 2, in the propulsion unit shown in FIG. 4, the orientation of the stepped planetary gear 15 is reversed. In particular, in this example embodiment, the positions of the planet gear 151 having a large diameter and of the planet gear 152 having a small diameter are interchanged. As in the example embodiment shown in FIG. 2, the sun gear 18 having a large diameter is engaged with the planet gear 152 having a small diameter. Furthermore, the output gear 10 is connected to the ring gear 14 having a small diameter, while the crank axle 30 is connectable to the ring gear 12 having a large diameter. The further configuration of the propulsion unit shown in FIG. 4 corresponds to that of the propulsion unit shown in FIG. 2. By this configuration, an alternative transmission ratio can be obtained.

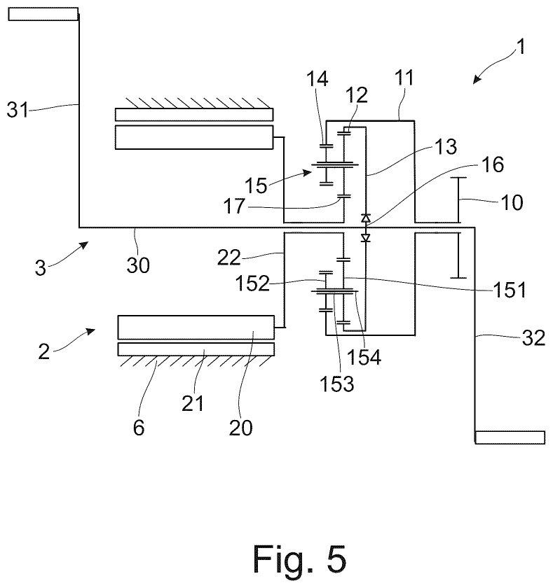

FIG. 5 shows a modification of the example embodiment shown in FIG. 1. In deviation from the configuration of the propulsion unit shown in FIG. 1, in the propulsion unit shown in FIG. 5, the orientation of the stepped planetary gear 15 is reversed. In particular, in this example embodiment, the positions of the planet gear 151 having a large diameter and of the planet gear 152 having a small diameter are interchanged. As in the example embodiment shown in FIG. 1, the sun gear 17 having a small diameter is engaged with the planet gear 151 having a large diameter. Furthermore, the output gear 10 is connected to the ring gear 14 having a small diameter, while the crank axle 30 is connectable to the ring gear 12 having a large diameter. The further configuration of the propulsion unit shown in FIG. 5 corresponds to that of the propulsion unit shown in FIG. 1. By this configuration, an alternative transmission ratio can be obtained.

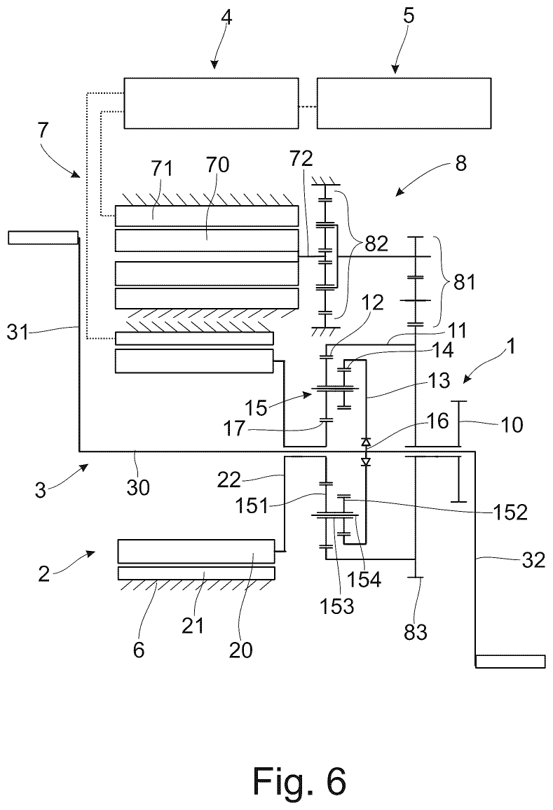

A propulsion unit according to a fourth example embodiment is explained in the following with reference to FIG. 6. As is apparent in FIG. 6, the propulsion unit has, in addition to the configuration shown in FIG. 1, an electrical propulsion unit 7, which is provided in addition to the electric machine 2. Furthermore, a reduction gear 8 is shown in the example embodiment according to FIG. 6. It is to be noted that the configuration of the electric machine 2, of the speed modulation gear 1, and of the crank device 3 is the same as the configuration of the propulsion unit shown in FIG. 1. However, the example embodiment shown in FIG. 6 can also be designed having the example embodiments according to FIG. 2 and FIG. 3 and the additionally described modifications, which are shown in FIG. 4 and FIG. 5.

In the present example embodiment, the electrical propulsion unit 7, which is provided in addition to the electric machine 2, is axially parallel to and offset from the axis of symmetry of the electric machine 2 and of the speed modulation gear 1. The electrical propulsion unit 7 has a rotor 70, which is rotatably mounted. Furthermore, the electrical propulsion unit 7 has a stator 71, which is attached to the housing 6 of the propulsion unit. An output element 72 is provided on the rotor 70 of the electrical propulsion unit 7. The output element 72 is connected to a planetary gear set 82, which is used to reduce the rotational speed at the output element 72 from the rotational speed of the electrical propulsion unit 7.

The planetary gear set 82 has an output element, which is connected on the input side to a spur gear set 81. The spur gear set 81 according to the present example embodiment has a gear, which is provided at the output element of the planetary gear set 82. This gear engages with an intermediate gear, which is engaged in turn with an input element 83 of the speed modulation gear. The input element 83 of the speed modulation gear 1 is in the form of a toothing on the circumference of the ring gear carrier 11. Therefore, in the present example embodiment, the planetary gear set 82 is provided in order to reduce the rotational speed of the electrical propulsion unit 7, and the spur gear set 81 is provided in order to compensate the axially parallel offset of the electrical propulsion unit 7 with respect to the axis of symmetry of the electric machine 2 and of the speed modulation gear 1.

The electrical propulsion unit 7 can be driven via the control device 4 and by utilizing electrical energy which is stored in the electrical energy store device 5. In an operating state in which the rider of the two-wheeled vehicle drives the crank axle 30 via the pedal cranks for forward travel of the two-wheeled vehicle, the speed modulation gear 1, in particular the ring gear carrier 11 with the input element 83 mounted thereon, rotates depending on the operating state of the electric machine 2. The electrical propulsion unit 7 can be driven according to a specification from the rider of the two-wheeled vehicle, so that the propulsive force of the electrical propulsion unit 7 is applied onto the input element 83 of the speed modulation gear 1. Therefore, the propulsive force applied by the rider of the two-wheeled vehicle via the pedal cranks can be supplemented with the propulsive force of the electrical propulsion unit. The system shown in FIG. 6 is therefore an electrically assisted drive of the type used in pedelecs or e-bikes, i.e., bicycles having electrical assistance.

Since the speed modulation gear 1 and the electric machine 2, which have already been described with reference to FIG. 1, are additionally provided, in this example embodiment the assistance function of the electrical propulsion unit 7 is combined with the function having a variable transmission ratio by the speed modulation gear 1 and the electric machine 2.

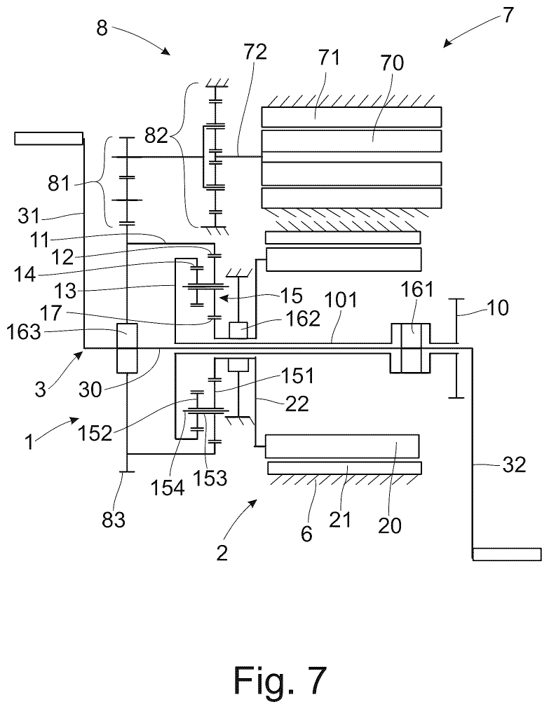

A propulsion unit according to a fifth example embodiment is explained with reference to the schematic view shown in FIG. 7. In the following, only differences between the configuration of the propulsion unit shown in FIG. 6 and the configuration shown in FIG. 7 are described.

In the example embodiment shown in FIG. 7, the propulsion unit has the electrical propulsion unit 7 and the reduction gear 8. The electrical propulsion unit 7 is configured similarly to that shown in FIG. 6 and the reduction gear 8 is configured similarly to that shown in FIG. 6. The configuration of the propulsion unit shown in FIG. 7 deviates from the configuration of the propulsion unit shown in FIG. 6 in that the crank axle 30 of the crank device 3 is configured to transmit the rotation onto the ring gear carrier 11. As a result, the rotation of the crank axle 30 is transmitted onto the ring gear 12 having a large diameter. In the present example embodiment, the rotation of the ring gear 12 having a large diameter is transmitted onto the planet gear 151 having a large diameter. The planet gear 151 having a large diameter is engaged with the sun gear 17 having a small diameter, which sun gear is connected to the electric machine 2. The planet gear 152 having a small diameter is engaged with the ring gear 14 having a small diameter. The ring gear 14 having a small diameter is coupled to the output gear 10 via the ring gear carrier 13.

In the example embodiment shown in FIG. 7, a freewheel unit 162 is provided, which freewheel unit can limit the rotation of the electric machine 2 with respect to the housing 6 in at least one direction of rotation. The freewheel unit 162 is in the form of an engageable and disengageable freewheel unit in the present example embodiment. Therefore, the rotation of the electric machine 2 can be advantageously prevented in predetermined operating states. In a deviating example embodiment, a permanently engaged freewheel unit 162 is provided between the crank axle 30 and the output gear 10, which freewheel unit permits a transmission of force between the crank axle 30 and the output gear 10 in only one direction of rotation. Furthermore, a freewheel unit 163 is provided in the present example embodiment between the crank axle 30 and the ring gear carrier 11, which freewheel unit permits the transmission of the rotation of the crank axle 30 onto the freewheel unit carrier 11 in only one direction of rotation.

By the example embodiments shown in FIG. 6 and FIG. 7, an electrically assisted propulsion unit for a two-wheeled vehicle having the function of a variable adjustment of the transmission ratio between the rotational speed of the crank axle and the rotational speed of the output gear is provided. The operation of the electrical propulsion unit 7 and of the electric machine 2, which is used for the rotational speed control, can be controlled by the control device 4. The electrical energy for operating the propulsion unit can be obtained from the electrical energy store device 5.

In a further example embodiment, the electrical propulsion unit 7 can be used for a recuperative operation. In this recuperative operation, the electrical propulsion unit 7 can be driven while the crank axle 30 is driven by the rider of the two-wheeled vehicle. The recuperation of the electrical propulsion unit 7 brought about by this drive can be used to generate energy. This energy can be used in turn for operating the electric machine 2, which is used for the rotational speed control. It is therefore possible to enable an operation that is battery-neutral.

By the propulsion unit shown in FIG. 6 and in FIG. 7, a recuperative braking mode can also be achieved. For this purpose, using known means, the electrical propulsion unit 7 can be switched into a recuperation mode by the control device 4, so that a braking torque is generated at the propulsion unit. The electrical energy generated by the recuperation mode of the electrical propulsion unit 7 can be stored in the battery or used for other purposes.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 speed modulation gear
10 output gear
11 ring gear carrier
12 ring gear with large diameter
13 ring gear carrier
14 ring gear with small diameter
15 stepped planetary gear
151 planet gear with large diameter
152 planet gear with small diameter
153 stepped planetary gear pin
154 stepped planet carrier
16 freewheel unit
161 freewheel unit
162 freewheel unit
163 freewheel unit
17 sun gear with small diameter
18 sun gear with large diameter
19 stepped planet spider
2 electric machine for rotational speed control
20 rotor
21 stator
22 output element
3 crank device
30 crank axle
31, 32 crank arm
4 control device
5 electrical energy store device
6 housing
7 electrical propulsion unit
70 rotor
71 stator
72 output element
8 reduction gear
81 spur gear set
82 planetary gear set
83 speed modulation gear input element

1-19. (canceled)

20. A propulsion unit for a vehicle operable by muscle power, the propulsion unit comprising:
a crank (3) configured for receiving muscle power;
a speed modulation gear (1) for transmitting the muscle power onto an output gear (10) via which a propulsive force for propelling the vehicle is output, the speed modulation gear (1) comprising a stepped planetary gear set with at least one stepped planetary gear (15), a plurality of ring gears (12, 14), and an input element (17; 18; 19);
an electric machine (2); and
a housing (6) mountable on the vehicle for accommodating at least some elements of the propulsion unit,
wherein the crank (3) is couplable to one of the ring gears (12, 14) of the stepped planetary gear set, and an output element (22) of the electric machine (2) is coupled to the input element (17; 18; 19) of the stepped planetary gear set, and
wherein the speed modulation gear (1) is mounted rotatably with respect to the housing (6) such that rotation of the electric machine (2) and rotation of the crank (3) are superimposable and transmittable onto the output gear (10).

21. The propulsion unit of claim 20, wherein:
the stepped planetary gear (15) comprises a planet gear (151) with a large diameter and a planet gear (152) with a small diameter, the planet gear (151) with the large diameter coupled to the planet gear (152) with the small diameter;
the speed modulation gear (1) also comprises a ring gear (12) with a large diameter and a ring gear (14) with a small diameter, the ring gear (12) with the large diameter engaging with the planet gear (151) having a large diameter, the ring gear (14) with the small diameter engaging with the planet gear (152) having the small diameter.

22. The propulsion unit of claim 21, wherein:
the speed modulation gear (1) comprises a sun gear (17) with a small diameter, the sun gear (17) with the small diameter engaging with the planet gear (151) having the large diameter;
the planet gear (152) having the small diameter engages only with the ring gear (14) having the small diameter; and
the sun gear (17) having the small diameter forms the input element (17) coupled to the output element (22) of the electric machine (2).

23. The propulsion unit of claim 21, wherein:
the speed modulation gear (1) comprises a sun gear (18) with a large diameter, the sun gear (18) with the large diameter engaging with the planet gear (152) having the small diameter;
the planet gear (151) having the large diameter engages only with the ring gear (12) having the large diameter; and
the sun gear (18) having the large diameter forms the input element (18) coupled to the output element (22) of the electric machine (2).

24. The propulsion unit of claim 21, wherein:
the speed modulation gear (1) comprises a stepped planet spider (19) holding the at least one stepped planetary gear (15) such that the at least one stepped planetary gear (15) is rotatable and is movable on a circular path about an axis of symmetry of the speed modulation gear (1);
the stepped planet spider (19) forms the input element (19) coupled to the output element (22) of the electric machine (2); and
the stepped planetary gear (15) engages only with the plurality of ring gears (12, 14).

25. The propulsion unit of claim 21, wherein the electric machine (2) and the speed modulation gear (1) are disposed coaxially.

26. The propulsion unit of claim 21, further comprising a freewheel unit provided in a force transmission path between the crank (3) and the speed modulation gear (1), the freewheel unit configured to transmit force in only one direction of rotation.

27. The propulsion unit of claim 21, further comprising an electrical propulsion unit (7) coupled to the input element (83) of the speed modulation gear (1) via an output element (72) of the electrical propulsion unit (7) such that propulsive force of the electrical propulsion unit (7) is transmittable onto the output gear (10) of the speed modulation gear (1).

28. The propulsion unit of claim 27, further comprising a reduction gear (8) configured for reducing a rotational speed output by the electrical propulsion unit (7), the reduction gear (8) provided between the output element (72) of the electrical propulsion unit and the input element (83) of the speed modulation gear (1).

29. The propulsion unit of claim 28, wherein the reduction gear (8) comprises one of a planetary gear set (82) and a spur gear set (81).

30. The propulsion unit of claim 27, wherein the electrical propulsion unit (7) is axially offset relative to the speed modulation gear (1) and the electric machine (2).

31. The propulsion unit of claim 27, wherein propulsive force of the electrical propulsion unit (7) is applied directly onto an element of the speed modulation gear (1) that supports the output gear (10).

32. The propulsion unit of claim 20, wherein:
the plurality of ring gears comprises a ring gear (14) having a small diameter and a ring gear (12) having a large diameter; and
the crank (3) is coupleable to the ring gear (14) having the small diameter or to the ring gear (12) having the large diameter.

33. The propulsion unit of claim 21, wherein propulsive force of the electrical propulsion unit (7) is applied onto the output gear (10) of the speed modulation gear (1) after passing through the speed modulation gear (1).

34. The propulsion unit of claim 20, wherein the output element (22) of the electric machine (2) is fixable with respect to the housing (6) via a freewheel unit.

35. The propulsion unit of claim 20, further comprising a control device (4) configured to controls rotational speed and direction of rotation of the electric machine (2) based on supplied information such that a predetermined ratio between the rotational speed of the crank (3) and the output gear (10) is set.

36. The propulsion unit of claim 27, wherein the electrical propulsion unit (7) is configured for a recuperative operation such that at least some of the electrical energy generated in the recuperative operation is available for operating the electric machine (2).

37. The propulsion unit of o claim 20, further comprising an electrical energy storage device (5) configured to provide electrical energy for operating the propulsion unit.

38. A micromobility vehicle, comprising: at least two wheels; and the propulsion unit of claim 20, wherein the output gear (10) is coupled to one of the wheels via a force transmission element for propelling the micromobility vehicle.
